(19) United States
(12) Patent Application Publication
(10) Pub. No.: US 2003/0126188 A1
(43) Pub. Date: Jul. 3, 2003

(54) Generic header parser providing support for data transport protocol independent packet voice solutions

(75) Inventors: D.C. John Ta, Laguna Niguel, CA (US); Rong-Feng Chang, Irvine, CA (US)

Correspondence Address: LAW OFFICE OF LAWRENCE E LAUBSCHER, JR, 1160 SPA RD, SUITE 2B, ANNAPOLIS, MD, 21403, US

(73) Assignee: Zarlink Semiconductor V.N. Inc., Irvine, CA

(21) Appl. No.: 10/033,498

(22) Filed: Dec. 27, 2001

(51) Int. Cl. G06F 9/00

(52) U.S. Cl. 709/108

(57) ABSTRACT

A method and apparatus for processing packets carrying a voice payload are presented. The apparatus provides for the reduction of packet transport overheads by embedding a context switching header within pre-existing data transport protocol headers using spare bits as much as possible. The solution provides configurable support for multi-vendor equipment. Provisions are made for the hardware extraction of the context switching header from the packets as well as for the extraction of packets carrying a voice payload from a stream of packets carrying a mixed data traffic. The hardware extraction is supported using bit masks.

### FIELD OF THE INVENTION

The invention relates to data telecommunications, and in particular to methods and apparatus for conveying voice data using packet switching technologies.

### BACKGROUND OF THE INVENTION

Telecommunications services provided can be largely divided into two main categories.

The first category includes toll grade voice communications services which provide a quality-of-service characterized by: a minimum transmission delay, a minimal transmission jitter, a fixed pre-allocated bandwidth, low loss tolerance, using dedicated and redundant connections. Jitter refers to the variation of transmission delay of sequential signal transmissions between stations. Such telecommunication services include the: Plain Old Telephone Service (POTS), facsimile services, as well as video conferencing services. The equipment necessary to support toll grade voice services has a fixed hierarchical interconnection topology and is expensive to deploy, maintain and scale-up.

The second category includes best effort data services which have relaxed data transport requirements at reduced deployment, maintenance and expansion costs. The data transport benefits from a variable bandwidth. A flexible interconnection topology enables connectionless data transport routable around failed equipment. The proverbial price being paid by an unbound transmission delay, an unbound transmission jitter without any guarantees made as to the successful conveyance of data to the intended destination. Best effort data services are used in implementing what is known today as the Internet. The data transport equipment necessary to support data services is relatively inexpensive to deploy, maintain and scale-up compared to the equipment necessary to provide voice services presented above.

Telecommunications service providers typically provide the voice service (telephone service) as well as the data service (Internet access) in parallel. The parallel provision suffers from an increased management overhead. At the same time the parallel provisioning represents a necessity as the “last mile” connectivity for Internet access is typically provided over twisted pair physical links associated with telephone service provisioning.

Recently however, considerable progress has been made with respect to data transport equipment in support of faster, more reliable data service provisioning. The latest technological advancements in support of data services rival voice services such that the “best effort” qualifier no longer describes the data transport. A “Quality-of-Service” qualifier ascribed to data services is becoming more and more prevalent.

As most of the recent capital expenditure and deployment of telecommunications services has been associated with data service provisioning while the voice network has remained relatively unchanged, there is a market demand to leverage the newly installed infrastructure to deliver voice services. In particular, data transport protocols and data transport equipment have been devised to provision voice services over the Internet. The most promising attempts include a Voice over Internet Protocol (VoIP) technologies.

As the name suggests, VoIP technologies leverage Internet Protocol data transport technologies to convey data traffic associated with voice services. The combination is also loosely know as: packet-voice service, packet-switched voice service, etc. Although initially voice communications were centered around the analog transmission of voice signals, the digitization of voice signals is not new.

Digital format voice signal transmission was introduced with the advent of the digital telephone switch (digital exchange office). In digitizing analog voice signals, samples are taken every 125 μs and each voice signal amplitude sample is represented digitally using 8 bits. Where twisted copper wire pairs were used to exclusively transmit analog voice signals, the advent of the digital telephone switch made it possible to multiplex digital voice signals by combining multiple digital voice signals over the same wire using Time Division Multiplexing (TDM). TDM technologies enable multiple signals to time-share the copper wire transmission media also known loosely as digital trunks. Provisions are also made for control and synchronization information to be transmitted.

A TDM transmission protocol defines time frames having a format and being transmitted every 125 μs to convey multiple 8 bit samples as generated. A variety of digital trunk capacities are defined, examples of which include: a North American T1 specification carrying voice data samples corresponding to 24 voice signal channels per frame along with control and synchronization information, and an European E1 specification carrying voice data samples corresponding to 32 voice signal channels per frame along with control and synchronization information. The synchronization and control information transmitted represents only a small fraction of the TDM data transport bandwidth.

The telephone network is largely a circuit switched network where dedicated connections are established between telephone stations prior to voice signal transmission. Paired physical copper wire links between analog telephone switching equipment were connected together to provide a dedicated full-duplex connection between telephone stations. In the digital telephone network, time slots, corresponding to voice samples conveyed in the frames exchanged between digital telephone exchanges via the digital trunks, are reserved for each telephone connection between telephone stations. Robustness is provided via redundant equipment on a hot stand-by basis. A parallel network provides a signaling function to set-up, monitor and tear down telephone connections.

VoIP technology, between other issues, concerns itself with the transport of voice data using data packets. FIG. 1 is a schematic diagram showing an exemplary packet configuration. Data packets 100 are self contained data structures including signaling and control information along with a data payload 120. The signaling and control information are combined in a header 110 having a format specified by data transport protocols used to convey the packet 100. Data transport protocols may specify the use of a trailer 130.

Each data packet 100 is transmitted, routed, and conveyed in the data transport network independent of other data packets 100. A forwarding decision is made in processing each packet 100 at each data transport node of a data transport network. This process is know as packet switching.

On one hand, when compared to TDM data transmission, the packet header 110 represents a large overhead reducing the data transport capacity available. On the other hand, making decisions at each data network node in the path taken by the packet 100 through the data transport network, enables the routing of packets 100 around failed equipment, thus not necessitating redundant deployment of data transport equipment. The installation and synchronization of redundant equipment is very expensive representing yet another reason for the push behind packet switched voice services.

As mentioned above, voice services require low transmission delays and a bound jitter. Internet Protocol (IP) packet transmission does not address transmission delay issues, neither does it attempt to control jitter. In fact, the IP protocol data transmission is not reliable. IP packets may be lost in transmission or can even arrive out of sequence. That said, only an upper bound is necessary on IP packet loss in conveying voice samples as the human ear is tolerant to some extent.

The IP protocol is representative of an Open System Interconnection (OSI) Layer-3 data transmission technology. Higher layer protocols are used to address different packet transmission parameters. An OSI Layer-4 Transmission Control Protocol (TCP) is used in conjunction with the IP protocol to provide reliable transmission without addressing transmission delay or jitter. An Virtual Local Area Networking (VLAN) protocol provides for forwarding priorities specifying a preferential processing of VLAN tagged packets ensuring, at best, a reduced but not bound processing delay.

The recent explosive development of telecommunication technologies has brought about a large number of equipment vendors on the market. All these vendors have differing approaches to solve the problems presented above while introducing yet another complicating factor relating to inter-vendor interoperability of the VoIP equipment. Inter-vendor interoperability is rarely considered at the design stage leading to proprietary solutions.

An attempt to alleviate some of the issues presented above has been made by World Telecom Labs, a Belgian entity, and published on the Internet at http://www.wtlusa.com/prod_tek/voip_wp.pdf as “The INX VOIP Solution”. Although unique, the INX solution attempts to reduce the packet header overhead by imposing a telephone network-like topology: requiring the use of a star network topology, having interconnected nodes via point-to-point links only, and replacing the packet header 110 of each packet 100 transmitted over each point-to-point link with a 4 byte proprietary header. Although the solution tries to mimic the circuit-switched telephone network it provides only a proprietary solution limited to one vendor equipment. To reduce jitter, the INX solution requires the buffering of voice samples in various buffers in the data network at the expense of large buffers and incurred delay. The requirement of the buffering of voice samples in the resulting network does not lend itself to a scaleable solution in support of higher voice data transport capacities. Further, signaling is implemented via a User Datagram Protocol (UDP) which although provides for a fast conveyance of signaling messages, is not reliable. All data paths are periodically tested by sending test UDP packets, at an increased bandwidth requirement, and potentially causing unnecessary re-routing of voice packets on failing such tests due to lost UDP packets.

There therefore is a need to solve the above mentioned issues, and in particular it is necessary to provide methods and apparatus for processing of VoIP packets with an improved efficiency in a multi-vendor environment while reducing data transport overheads.

### SUMMARY OF THE INVENTION

In accordance with an aspect of the invention, a data network node processing packets carrying a voice payload is provided. The data network node includes: a plurality of physical interfaces conveying packets, at least one bit mask specification associated with at least one of the plurality of physical interfaces and a bit mask comparator. The bit mask specifies bit values and bit locations within at least one selected portion of the packets received by at least one physical interface. The bit mask comparator compares the selected portion of at least one of the packets with the at least one bit mask, to determine whether the received packet carries a voice payload. Layer-by-layer decapsulation of packets is bypassed reducing processing overheads at the data network node.

In accordance with an aspect of the invention, a physical network interface conveying packets carrying a voice payload is provided. The physical network interface includes: a least one bit mask specification and a bit mask comparator. The bit mask specifies bit values and bit locations within at least one selected portion of the received packets. The bit mask comparator compares the selected portion of at least one of the packets received with the at least one bit mask, to determine whether the packet carries a voice payload. Layer-by-layer decapsulation of packets is bypassed to reduce processing overheads at the physical network interface.

In accordance with yet another aspect of the invention, a method is provided for selectively processing packets carrying a voice payload. The method includes a sequence of steps. In a first step received packets are buffered in an input buffer. At least a selected portion of each buffered packet is compared against a selected bit mask. A determination is made whether the packet carries a voice payload. Layer-by-layer decapsulation of received packets is bypassed to reduce processing overheads.

The advantages are derived from the reduction of packet transport overheads by embedding a context switching header within pre-existing headers using spare bits as much as possible. The solution provides configurable support for multi-vendor equipment. Further processing overheads are reduced in the hardware extraction of the context switching header from the packets as well as for the extraction of packets carrying a voice payload from a stream of packets carrying a mixed data traffic.

### BRIEF DESCRIPTION OF THE DRAWINGS

The features and advantages of the invention will become more apparent from the following detailed description of the preferred embodiment(s) with reference to the attached diagrams wherein:

FIG. 1 is a schematic diagram showing an exemplary packet configuration;

FIG. 2 is a schematic diagram showing an exemplary OSI Layer-2 Internet Protocol packet configuration providing transport for voice payloads;

FIG. 3 is a schematic diagram showing an exemplary generic OSI Layer-3 Internet Protocol packet configuration providing transport for voice payloads;

FIG. 4 is a schematic diagram showing a general packet configuration providing transport for voice payloads in accordance with an exemplary embodiment of the invention;

FIG. 5 is a schematic diagram showing bits of a 2 byte context switching header used in processing voice payloads in accordance with a preferred embodiment of the invention;

FIG. 6 is a schematic diagram showing, in accordance with the preferred embodiment of the invention, a bit mask used in extracting VoIP packets from a stream of IP packets; and

FIG. 7 is a schematic diagram showing, in accordance with a preferred embodiment of the invention, process steps in receiving and transmitting VoIP packets.

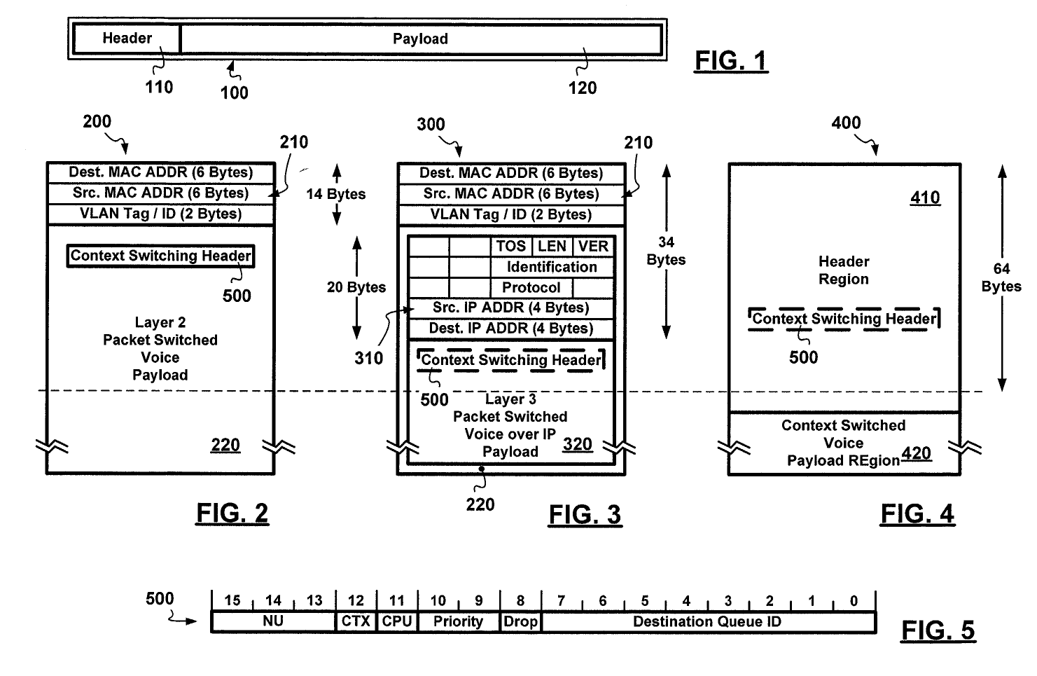

It will be noted that in the attached diagrams like features bear similar labels.

### DETAILED DESCRIPTION OF THE EMBODIMENTS

In accordance with the invention, it is recognized that different equipment vendors implement VoIP technologies differently. Different data transport protocols (OSI Layer-2 and -3) are used over different OSI Layer-1 technologies. Examples of OSI Layer-2 data transport technologies include, but are not limited to: Ethernet and Token-Ring technologies. The IP protocol operates at OSI Layer-3, while TCP, Real-Time Transfer Protocol (RTP) and UDP operate at OSI Layer-4. Vendor specific VoIP implementations may take the form of, but not limited to: IP/UDP/RTP using Token-Ring physical links, as well as TCP over IP using Ethernet physical links.

In accordance with a preferred embodiment of the invention, VoIP packets are preferentially processed at data network nodes through extraction thereof from the IP packet streams. A physical network interface selectively supporting multiple data transport protocols is provided.

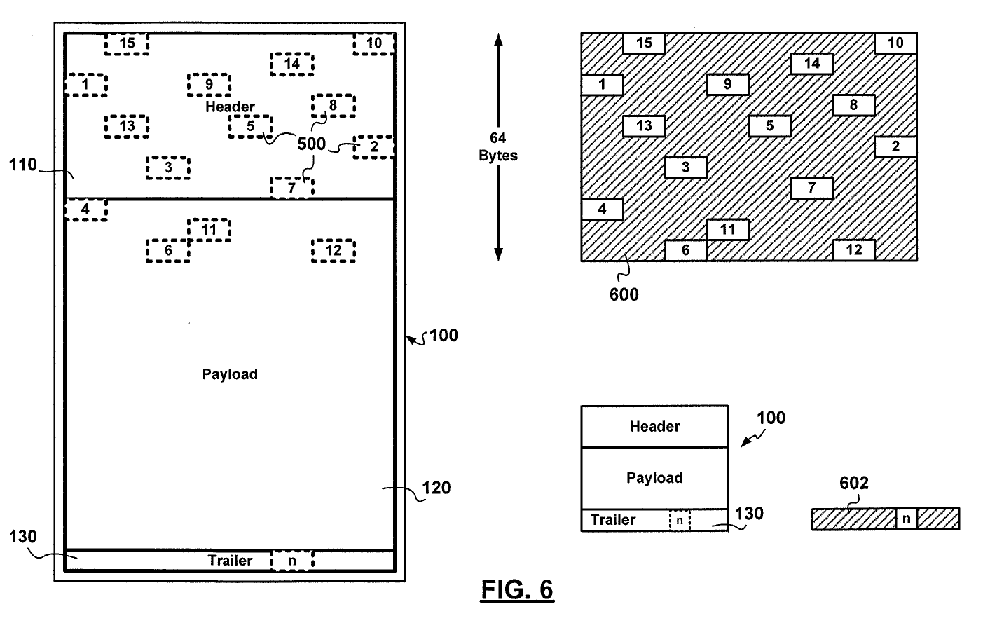

FIG. 2, FIG. 3, FIG. 4 are schematic diagrams showing, in accordance with the invention, exemplary IP packet configurations providing transport for voice payloads.

FIG. 2 shows a preferred packet configuration for transport of voice payloads using an Ethernet packet 200 having only a 14 byte header 210 and a payload 220.

FIG. 3 shows a generic IP packet for voice data transport. The exemplary packet shown is an Ethernet packet having a 14 byte Ethernet header 210 specifying Media Access Control (MAC) addresses and potentially a VLAN tag ID. The Ethernet packet 300 encapsulates, in its payload 220, a 20 byte long IP header 310 and a voice payload 320. Different OSI Layer-4 transmission protocols may be used and, if so, specified via a Protocol specifier field in the IP header 310. For example: protocol specification value 2 corresponds to the Internet Group Management Protocol (IGMP), protocol specification value 6 corresponds to the TCP protocol, protocol specification value 17 corresponds to the UDP protocol, etc.

In accordance with the invention, the conveyance of voice payloads may use any packet 400 format shown in FIG. 4. The generic packet 400 has a header portion 410 and a voice payload 420. Preferably a context switching header 500 is used to enable voice data processing along the transport path.

FIG. 5 is a schematic diagram showing, in accordance with a preferred embodiment of the invention, bits of a 2 byte context switching header 500 used in processing voice payloads.

In accordance with the preferred embodiment of the invention, it is realized that the Layer-2, -3, and -4 data transfer protocol header specifications do not define uses for all bits in the headers. Put another way, without using additional data transport bandwidth, the 2 byte context switching header 500 is preferably embedded in the existing headers 210/310/410 specified by the data transport protocols used in conveying voice data in providing a VoIP solution as much as there are spare bits available. Although the context switching header 500 is shown in FIG. 2, FIG. 3, FIG. 4, and FIG. 5 as a sequence of bits, the actual embedding of the bits within the headers 210/310/410 need not be ordered—not even sequential. Further, the embedding of the context switching header 500 need not be exclusive to one of the headers 210/310/410 buy may be spread out over a combination of the headers 210/310/410.

FIG. 6 is a schematic diagram showing, in accordance with the preferred embodiment of the invention, a bit mask used in extracting VoIP packets from a stream of IP packets.

In accordance with the preferred embodiment of the invention, the first 64 bytes of the packet 100 are used to embed the context switching header 500. Depending on the data transmission protocol(s) used, the context switching header 500 is embedded in a combination of the packet header 110 and the payload 120. The preferred embedding of the context switching header 500 does not add any additional data transport overhead as unassigned bits in protocol headers 110 (210/310/410) are used selectively to support a variety of implementations as well as interworking with multi-vendor equipment.

In accordance with the preferred embodiment of the invention, the extraction of the context switching header 500 is performed in hardware to reduce packet processing overheads.

Preferably, the hardware extraction of the context switching header 500 includes the use of a bit mask 600 specifying context switching header constituent bit sequence assignments and locations within the first 64 bytes of the packet 100.

In accordance with another preferred embodiment of the invention, in which VoIP data traffic shares data transport resources of the data transport network with other IP data flows, the bit mask 600 also specifies other bits used by data transmission protocol header fields in headers 210/310/410 to separate the VoIP data traffic from the other IP data traffic. As an example, the VoIP data traffic may be exchanged only with particular data network nodes having either specific MAC addresses or specific IP addresses. In accordance with a further embodiment of the invention, complete header fields having specific values may be specified in the bit mask 600 for processing voice data traffic transported in accordance with a particular group of data transport protocols.

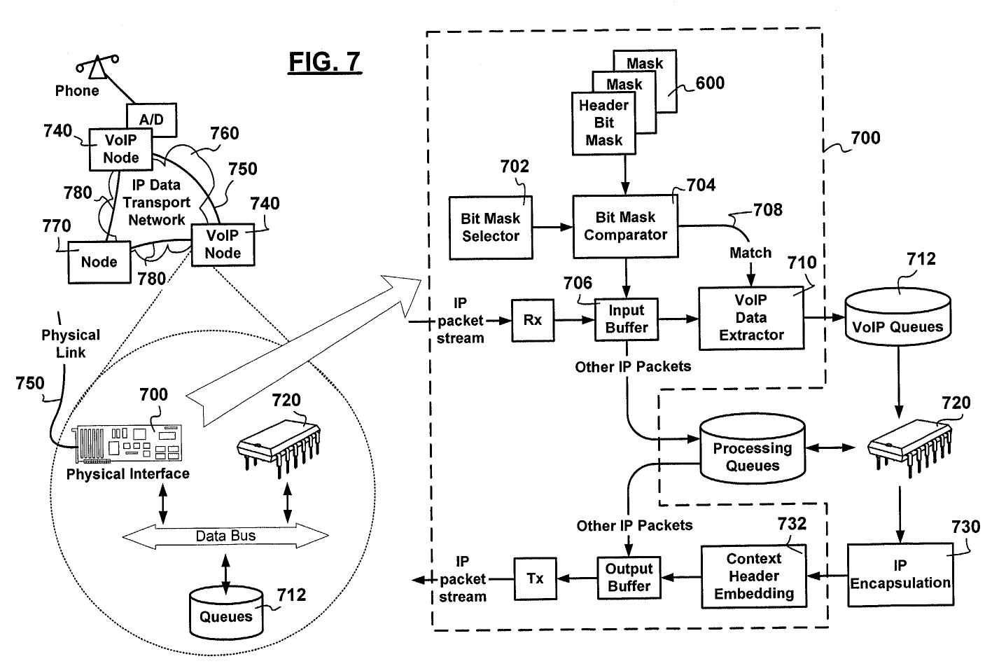

FIG. 7 is a schematic diagram showing, in accordance with a preferred embodiment of the invention, process steps in receiving and transmitting VoIP packets.

In accordance with the preferred embodiment of the invention, a plurality of bit maps 600 are provided at the hardware physical interface level; for example on a physical data network interface card 700 schematically shown in FIG. 7. A bit mask selector 702 is used to direct a bit mask comparator 704 to use a particular bit mask 600 to match against IP packets received in an input buffer 706.

Should a match be found, a signal 708 is sent to a VoIP data extractor 710. The VoIP data extractor 710 extracts at least the context switching header 500 bits and possibly the VoIP payload. The context switching header information is used to forward the VoIP payload to various VoIP queues 712 for preferential processing by a processor 720.

Subsequent to processing, VoIP data is encapsulated in IP packets 730 and a context switching header 500 is embedded prior to transmission thereof.

Typical IP packet processing methods known in the art are used to process other conveyed IP packets.

The method presented above may be implemented in data network nodes carrying IP data traffic; such nodes 740 being referred to as VoIP nodes 740 while the interconnecting physical links 750 are referred to as VoIP physical links 750 to provide support for voice services such as telephone services. VoIP nodes 740 and VoIP physical links 750 may participate in an IP data transport network 760 along with other IP data network nodes 770 interconnected via IP physical links 780.

Persons of ordinary skill in the art would recognize that the methods presented herein are not limited to the provisioning of telephone services. The methods may be used with minor changes to provision such as, but not limited to: facsimile transfer, telephone conferencing, video conferencing, user-to-user information including but not limited to caller identification, numeric paging, text messaging, voice mail, etc.

Persons of ordinary skill in the art, would recognize that selected data transport protocols specify the use of variable headers. In such cases, the bit mask 600 used to extract the context switching header 500 may either be segmented, or different bit masks may preferably be used if only a relatively small number of header variations are possible. The use of a varied header is typically specified in the header itself, implementations are contemplated in which the bit mask selector 702 makes use of the varied header specifications to select a correct bit mask 600.

Persons of ordinary skill in the art would recognize that selected data transport protocols specify the use of trailers in addition to headers. Trailer stored information typically but not exclusively provides for error checking. The use of trailers provides for additional opportunities to minimize the data transmission overhead by also making use of (although not preferred) available spare bits in the trailer. A segmented bit mask, as described above, would be necessary. The insert of FIG. 6 shows such an embodiment using a segmented bit mask 600/602.

Although the elements of the invention have been presented making exemplary reference to Internet Protocol related data transport technologies the invention is not limited thereto: a person of ordinary skill in the art would recognize that the invention may also be applied to other data transport technologies. The methods presented herein can also be adapted to process data traffic conveyed within a data transport node across a backplane between multiple physical interfaces (line cards) and/or service cards.

The embodiments presented are exemplary only and persons skilled in the art would appreciate that variations to the above described embodiments may be made without departing from the spirit of the invention. The scope of the invention is solely defined by the appended claims.

We claim:

1. A data network node processing packets carrying a voice payload comprising:
a. a plurality of physical interfaces conveying packets,
b. a least one bit mask specification associated with at least one of the plurality of physical interfaces, the bit mask specifying bit values and bit locations within at least one selected portion of at least one of the conveyed packets,
c. a bit mask comparator for comparing the selected portion of the at least one of the packets received via the at least one physical interface with the at least one bit mask, to determine whether the received packet carries a voice payload
wherein layer-by-layer decapsulation of packets carrying a voice payload is bypassed to reduce processing overheads at the data network node.

2. A data network node as claimed in claim 1, wherein the bit mask further specifies bit locations of bits making up a context switching header used to convey processing information regarding the conveyed packets.

3. A data network node as claimed in claim 2, wherein the bit locations of the bits making up the context switching header, further specify bit locations of available spare bits within at least one packet header, the use of available spare bits providing a data transport overhead reduction.

4. A data network node as claimed in claim 2, wherein the bit locations of the bits making up the context switching header, specify bit locations within the selected portion of packets.

5. A data network node as claimed in claim 1, wherein the selected portion includes at least one of: the first 64 bytes of the packet, the packet header and a packet trailer.

6. A physical network interface conveying packets carrying a voice payload, the physical network interface comprising:
a. a least one bit mask specification, the bit mask specifying bit values and bit locations within at least one selected portion of received at least one of the conveyed packets,
b. a bit mask comparator for comparing the selected portion of at least one of the packets received, with the at least one bit mask, to determine whether the received packet carries a voice payload
wherein layer-by-layer decapsulation of packets carrying a voice payload is bypassed to reduce processing overheads at the physical network interface.

7. A physical network interface as claimed in claim 6, wherein the bit mask further specifies bit locations of bits making up a context switching header used to convey processing information regarding the conveyed packets.

8. A physical network interface as claimed in claim 7, wherein the bit locations of the bits making up the context switching header, further specify bit locations of available spare bits within at least one packet header, the use of available spare bits providing a data transport overhead reduction.

9. A physical network interface as claimed in claim 7, wherein the bit locations of the bits making up the context switching header, specify bit locations within the selected portion of packets.

10. A physical network interface as claimed in claim 6, wherein the selected portion includes at least one of: the first 64 bytes of the packet, the packet header and a packet trailer.

11. A method of selectively processing packets carrying a voice payload comprising the steps of:
a. buffering a received packet in an input buffer;
b. comparing at least one selected portion of the packet with a selected bit mask; and
c. determining whether the packet carries a voice payload
wherein the layer-by-layer decapsulation of packets carrying a voice payload is bypassed to reduce processing overheads.

12. A method as claimed in claim 11, wherein determining whether the packet carries a voice payload, the method further comprises a step of selectively extracting a context switching header, if the packet is in fact carrying a voice payload.

13. A method as claimed in claim 11, wherein subsequent to determining whether the packet carries a voice payload, the method further comprises a step of selectively extracting a voice payload from the packet, if the packet is in fact carrying a voice payload.
